(19) United States
(12) Patent Application Publication
(10) Pub. No.: US 2026/0138638 A1
(43) Pub. Date: May 21, 2026

(54) VEHICLE

(71) Applicant: TOYOTA JIDOSHA KABUSHIKI KAISHA, Toyota-shi (JP)

(72) Inventor: Yuki SUGANO, Nagoya-shi (JP)

(73) Assignee: TOYOTA JIDOSHA KABUSHIKI KAISHA, Toyota-shi (JP)

(21) Appl. No.: 19/296,117

(22) Filed: Aug. 11, 2025

(30) Foreign Application Priority Data
Nov. 20, 2024 (JP) 2024-202414

(51) Int. Cl. B60W 60/00; B60N 2/00; B60W 40/08

(52) U.S. Cl. CPC B60W 60/001; B60N 2/003; B60W 40/08; B60W 2040/0881; B60W 2540/12

(57) ABSTRACT

The vehicle is configured to be detachable with an ADK that issues an instruction for autonomous driving and to be capable of autonomous driving. The vehicle includes a VP, a BP that receives a braking operation of a driver of the VP, a brake system that brakes the VP in accordance with the braking operation received by the BP or a braking instruction from the ADK, a driver presence/absence detector that detects whether the driver is present in the vehicle, and a VCIB that relays control communication between the ADK and the brake system. The VCIB determines whether the driver gets on the vehicle by using the detection result of the driver presence/absence detector, and when the VCIB determines that the driver gets on the vehicle, outputs the BP intervention signal of the value (0, 1, 2) according to the braking operation received by the BP to the ADK.

### CROSS-REFERENCE TO RELATED APPLICATION

This application claims priority to Japanese Patent Application No. 2024-202414 filed on November 20, 2024. The disclosure of the above-identified application, including the specification, drawings, and claims, is incorporated by reference herein in its entirety.

### BACKGROUND

### 1. Technical Field

The present disclosure relates to a vehicle, and more particularly, to a vehicle configured to enable autonomous driving through an autonomous driving kit that is attachable and detachable and that issues an instruction for autonomous driving.

### 2. Description of Related Art

In the related art, there is a vehicle configured to enable autonomous driving through an autonomous driving kit (hereinafter referred to as an “autonomous driving kit (ADK)”) that is attachable and detachable (for example, see Japanese Unexamined Patent Application Publication No. 2023-105002 (JP 2023-105002 A)). In the vehicle, a vehicle control interface box (hereinafter referred to as a “vehicle control interface box (VCIB)”) transmits an intervention signal of a brake pedal by a driver of the vehicle to the ADK.

### SUMMARY

In JP 2023-105002 A, the presence or absence of depression of the brake pedal is determined from a brake depression amount. However, the brake pedal may move due to a factor other than an operation of the driver. Therefore, there is a possibility that the depression of the brake pedal is erroneously determined.

The present disclosure provides a vehicle capable of preventing an erroneous determination of a depression of a brake pedal.

The vehicle according to the present disclosure is configured enable autonomous driving through an autonomous driving kit that is attachable and detachable and that issues an instruction for autonomous driving. The vehicle includes

a vehicle platform,

a brake pedal configured to receive a braking operation of a driver of the vehicle platform,

a braking function unit configured to brake the vehicle platform corresponding to the braking operation received by the brake pedal or a braking instruction from the autonomous driving kit,

a driver detector configured to detect whether the driver is on board the vehicle, and

a vehicle control interface box configured to relay control communication between the autonomous driving kit and the braking function unit.

The vehicle control interface box is configured to:

determine whether the driver is on board the vehicle by using a detection result of the driver detector;

output, to the autonomous driving kit, a brake pedal intervention signal of a value corresponding to the braking operation received by the brake pedal, in a case where a determination is made that the driver is on board the vehicle; and

output, to the autonomous driving kit, a brake pedal intervention signal of a first value indicating that the braking operation is not performed, in a case where a determination is made that the driver is not on board the vehicle.

With such a configuration, in a case where a determination is made that the driver is not on board the vehicle, the brake pedal intervention signal indicating that the braking operation is not performed is output to the autonomous driving kit regardless of whether the braking operation is received by the brake pedal. As a result, it is possible to provide a vehicle capable of preventing an erroneous determination of the depression of the brake pedal.

The vehicle control interface box may be configured to output, to the autonomous driving kit, a brake pedal intervention signal of a second value that is different from the first value and indicating that the braking operation is not performed, in a case where a determination is made that the driver is on board the vehicle and the braking operation is not performed.

With such a configuration, it is possible to distinguish between a case where the driver is on board the vehicle and a case where the driver is not on board the vehicle and to notify the distinction to the autonomous driving kit.

The vehicle control interface box may be configured to output, to the autonomous driving kit, the brake pedal intervention signal of the second value, in a case where a determination is made that the driver is on board the vehicle and an operation amount of the brake pedal is smaller than a threshold value.

With such a configuration, it is possible to appropriately notify the autonomous driving kit that the brake pedal is not operated in a case where the driver is on board the vehicle.

The vehicle control interface box may be configured to:

output, to the autonomous driving kit, a brake pedal intervention signal of a third value indicating that the braking operation is performed, in a case where a determination is made that the driver is on board the vehicle, the operation amount of the brake pedal is larger than the threshold value, and a deceleration request corresponding to the operation amount of the brake pedal is lower than a system deceleration request including the braking instruction; and

output, to the autonomous driving kit, a brake pedal intervention signal of a fourth value indicating that the deceleration request due to the braking operation exceeds the system deceleration request, in a case where a determination is made that the driver is on board the vehicle, the operation amount of the brake pedal is larger than the threshold value, and the deceleration request corresponding to the operation amount of the brake pedal is higher than the system deceleration request including the braking instruction.

With such a configuration, it is possible to distinguish between the deceleration request due to the braking operation of the driver and the system deceleration request in a case where the driver is on board the vehicle and to notify the distinction to the autonomous driving kit.

The vehicle control interface box may be configured to further output a brake pedal position signal corresponding to an operation amount of the brake pedal by the driver to the autonomous driving kit.

With such a configuration, the operation amount of the brake pedal by the driver can be appropriately notified to the autonomous driving kit.

According to the present disclosure, it is possible to provide the vehicle capable of preventing the erroneous determination of the depression of the brake pedal.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an outline of a MaaS system in which a vehicle according to the embodiment of the present disclosure is used;

FIG. 2 is a diagram showing a configuration of the vehicle in more detail;

FIG. 3 is a functional block diagram of brake pedal control in a vehicle;

FIG. 4 is a diagram for describing a brake pedal intervention signal;

FIG. 5 is a time chart showing an example of the transition of the brake pedal intervention signal in the vehicle; and

FIG. 6 is a flowchart showing a flow of a brake pedal intervention process executed by the VCIB in the present embodiment.

### DETAILED DESCRIPTION OF EMBODIMENTS

Hereinafter, the embodiment of the present disclosure will be described in detail with reference to the drawings. Note that, in the drawings, the same or equivalent parts are denoted by the same reference numerals, and description thereof will not be repeated.

In the following embodiment, an example in which the ADK is mounted on a mobility as a service vehicle (MaaS vehicle) will be described. The autonomous driving kit is a tool that integrates a set of hardware and software for realizing autonomous driving, and is one embodiment of an autonomous driving system (ADS). The type of the vehicle on which the autonomous driving kit can be mounted is not limited to the MaaS vehicle. The autonomous driving kit can be applied to general vehicles that can implement autonomous driving.

### Entire Configuration

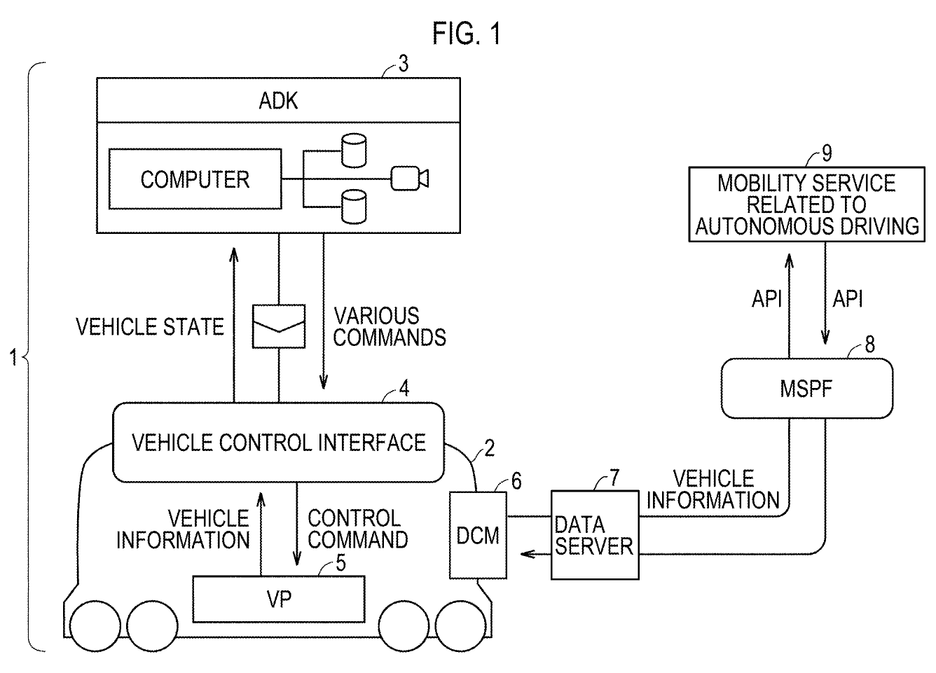

FIG. 1 is a diagram showing an outline of a MaaS system in which a vehicle 1 according to the embodiment of the present disclosure is used. With reference to FIG. 1, the MaaS system includes a vehicle 1. The vehicle 1 includes a vehicle body 2 and an autonomous driving kit (ADK) 3. The vehicle body 2 includes a vehicle control interface 4, a vehicle platform (VP) 5, and a data communication module (DCM) 6. The MaaS system includes a data server 7, a mobility service platform (MSPF) 600, and a mobility service 9 related to autonomous driving in addition to the vehicle 1.

The vehicle 1 can perform autonomous driving in response to a command from the ADK 3 attached to the vehicle body 2. Although the vehicle body 2 and the ADK 3 are shown at separated positions in FIG. 1, the ADK 3 is actually attached to a roof top or the like of the vehicle body 2.

The ADK 3 can also be removed from the vehicle body 2. In a case where the ADK 3 is removed, the vehicle body 2 can travel by the driving of the driver. In this case, the VP 5 executes traveling control in the manual mode (traveling control according to the driver operation).

The vehicle control interface 4 can communicate with the ADK 3 via a controller area network (CAN) or the like. The vehicle control interface 4 executes a predetermined application program interface (API) defined for each signal to be communicated. As a result, the vehicle control interface 4 receives various commands from the ADK 3 and outputs the state of the vehicle body 2 to the ADK 3.

When the vehicle control interface 4 receives the command from the ADK 3, the vehicle control interface 4 outputs the control command corresponding to the command to the VP 5. The vehicle control interface 4 acquires various pieces of information of the vehicle body 2 from the VP 5 and outputs the state of the vehicle body 2 to the ADK 3. The configuration of the vehicle control interface 4 will be described in detail later.

The VP 5 includes various systems and various sensors for controlling the vehicle body 2. The VP 5 executes the vehicle control in response to a command from the ADK 3 through the vehicle control interface 4. That is, the autonomous driving of the vehicle 1 is executed by the execution of the vehicle control by the VP 5 in response to the command from the ADK 3. The configuration of the VP 5 will also be described in detail later.

The ADK 3 is a kind of autonomous driving system (ADS) for performing autonomous driving of the vehicle 1. The ADK 3 creates, for example, a travel plan of the vehicle 1 and outputs various commands for traveling the vehicle 1 according to the created travel plan to the vehicle control interface 4 in accordance with an API defined for each command. The ADK 3 receives various signals indicating the state of the vehicle body 2 from the vehicle control interface 4 in accordance with the API defined for each signal, and reflects the received vehicle state in creating the traveling plan. The configuration of the ADK 3 (ADS) will also be described later.

The DCM 6 includes a communication interface for the vehicle body 2 to perform wireless communication with the data server 7. The DCM 6 outputs various pieces of vehicle information, such as speed, position, and autonomous driving state, to the data server 7. The DCM 6 receives various data for managing traveling of the autonomous driving vehicle including the vehicle 1 in the mobility service 9 related to autonomous driving, for example, from the mobility service 9 via the MSPF 8 and the data server 7.

The data server 7 is configured to wirelessly communicate with various autonomous driving vehicles including the vehicle 1, and is also configured to communicate with the MSPF 8. The data server 7 stores various data (vehicle state data and vehicle control data) for managing the traveling of the autonomous driving vehicle.

The MSPF 8 is a unified platform to which various mobility services are connected. Various mobility services in addition to the mobility service 9 related to autonomous driving can be connected to the MSPF 8. The various mobility services are, for example, various mobility services provided by a ride-sharing company, a car-sharing company, an insurance company, a car rental company, a taxi company, or the like. Various mobility services including the mobility service 9 can use various functions provided by the MSPF 8 according to the service content by using the API published on the MSPF 8.

The mobility service 9 related to autonomous driving provides the mobility service using the autonomous driving vehicle including the vehicle 1. The mobility service 9 can acquire, for example, driving control data of the vehicle 1 that communicates with the data server 7 and/or information stored in the data server 7 from the MSPF 8 by using the API published on the MSPF 8. The mobility service 9 transmits data for managing the autonomous driving vehicle including the vehicle 1 to the MSPF 8, for example, by using the API.

The MSPF 8 publishes an API for using various data of the vehicle state and the vehicle control needed for the development of the ADS. The operator of the ADS can use the data on the vehicle state and the vehicle control stored in the data server 7 as the API needed for the development of the ADS.

### Vehicle Configuration

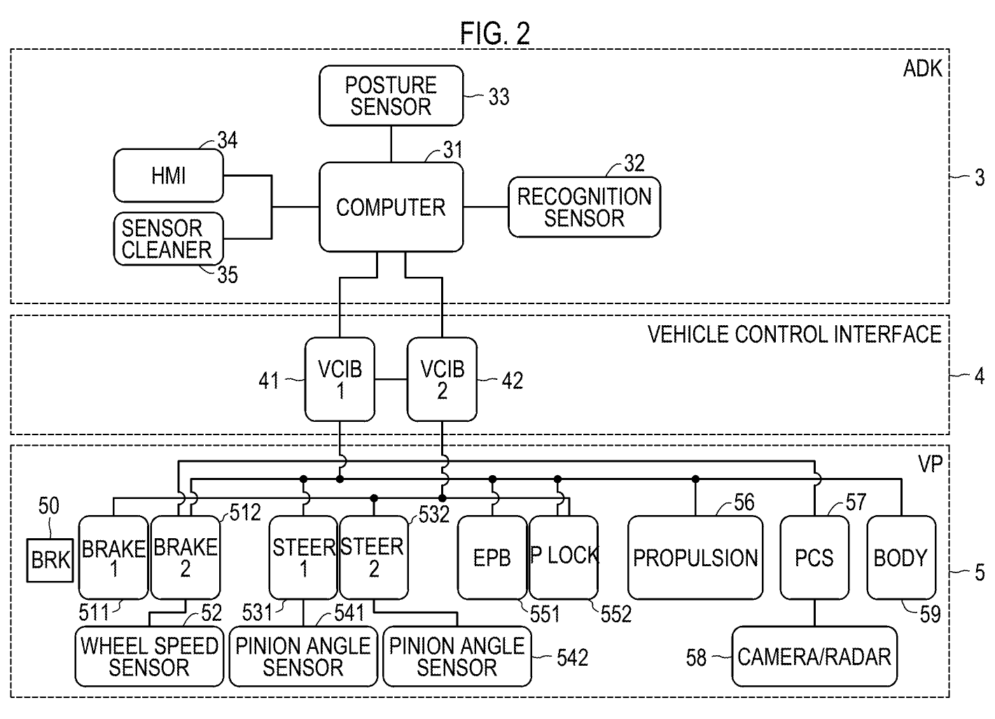

FIG. 2 is a diagram showing the configuration of the vehicle 1 in more detail. With reference to FIG. 2, the ADK 3 includes a computer 31, a recognition sensor 32, a posture sensor 33, a human machine interface (HMI) 34, and a sensor cleaner 35.

The computer 31 acquires the environment around the vehicle, the posture, behavior, and position of the vehicle 1 by using various sensors (described below) during autonomous driving of the vehicle 1. The computer 31 acquires the state of the vehicle 1 from the VP 5 via the vehicle control interface 4, and sets the next operation of the vehicle 1 (acceleration, deceleration, turning, and the like). The computer 31 outputs a command for realizing the set next operation to the vehicle control interface 4.

The recognition sensor 32 recognizes the environment around the vehicle. Specifically, the recognition sensor 32 includes at least one of a laser detection and ranging (LIDAR), a millimeter wave radar, and a camera.

The LIDAR measures a distance to a target object (a person, another vehicle, an obstacle, or the like) by irradiating the target object with infrared pulse laser light and measuring a time until the irradiation light is reflected and returns. The millimeter wave radar irradiates the target object with millimeter waves, detects millimeter waves reflected by the target object, and measures a distance to the target object and/or a direction of the target object. The camera is disposed, for example, on the back side of a room mirror in a vehicle cabin and captures an image in front of the vehicle 1. The image processing can be performed on the image captured by the camera by using an image processing processor equipped with artificial intelligence (AI). The information acquired by the recognition sensor 32 is output to the computer 31.

The posture sensor 33 detects the posture, behavior, and position of the vehicle 1. Specifically, the posture sensor 33 may include, for example, an inertial measurement unit (IMU) and a global positioning system (GPS).

The IMU detects, for example, the acceleration in the front-rear direction, the right-left direction, and the up-down direction of the vehicle 1, and the angular velocity in the roll direction, the pitch direction, and the yaw direction of the vehicle 1. The GPS detects the position of the vehicle 1 by using information received from a plurality of GPS satellites orbiting the earth. The information acquired by the posture sensor 33 is also output to the computer 31.

The HMI 34 includes, for example, a display device, a voice output device, and an operation device. Specifically, the HMI 34 may include a touch panel display and/or a smart speaker (AI speaker). The HMI 34 provides the user with the information or receives the operation of the user when the vehicle 1 is autonomously driven, when the vehicle 1 is driven in the manual mode, or when the mode is changed.

The sensor cleaner 35 is configured to remove dirt adhering to each sensor. More specifically, the sensor cleaner 35 removes dirt such as a camera lens, a laser irradiation unit, or a millimeter wave irradiation unit using a cleaning liquid or a wiper.

The vehicle control interface 4 includes the VCIBs 41, 42. The VCIB 41, 42 includes a processor, such as a central processing unit (CPU), and a memory, such as a read only memory (ROM) and a random access memory (RAM). Each of the VCIB 41, 42 is connected to be communicable with the computer 31 of the ADK 3. The VCIB 41, 42 are connected to be able to communicate with each other.

Each of the VCIB 41, 42 relays various commands from the ADK 3 and outputs the commands to the VP 5 as a control command. More specifically, each of the VCIBs 41, 42 uses a program or the like stored in the memory to convert various commands output from the ADK 3 into control commands used for controlling each system of the VP 5. Further, each of the VCIB 41, 42 outputs the control command to the system on the connection destination. In addition, each of the VCIB 41, 42 appropriately processes the vehicle information output from the VP 5 (including relaying) and outputs the vehicle information to the ADK 3 as the vehicle state.

Although the connection destination of the VCIBs 41, 42 to the systems configuring the VP 5 is partially different, the VCIBs 41, 42 have basically the same function. The control system between the ADK 3 and the VP 5 is redundant (duplicated) by the fact that the VCIB 41, 42 have the same function with respect to the operation of the brake system, the steering system, and the like. Therefore, even in a case where some kind of failure occurs in a part of the system, the function (steering, braking, and the like) of the VP 5 can be maintained by switching the control system or blocking the control system in which the failure has occurred.

The VP 5 includes the brake pedal 50, the brake systems 511, 512, the wheel speed sensors 52, the steering systems 531, 532, and the pinion angle sensors 541, 542. Further, the VP 5 includes an electric parking brake (EPB) system 551, a P-lock system 552, a propulsion system 56, a pre-collision system (PCS) 57, a camera/radar 58, and a body system 59.

The VCIB 41 is connected to the brake system 512, the steering system 531, and the P-lock system 552 among the systems of the VP 5 such that the systems can communicate with each other via a communication bus. The VCIB 42 is connected to the brake systems 511, 512 of the systems of the VP 5 and the steering system 532 to be able to communicate with each other via a communication bus. Further, the VCIB 42 is connected to the EPB system 551, the P-lock system 552, the propulsion system 56, and the body system 59 such that the EPB system 551, the P-lock system 552, the propulsion system 56, and the body system 59 can communicate with each other via a communication bus.

The brake pedal 50 receives a driver operation (depression operation). A brake position sensor that detects a depression amount of the brake pedal 50 is provided in the brake pedal 50.

The brake systems 511, 512 are configured to control a plurality of braking devices provided in each of the wheels of the vehicle 1. The braking device may include a disc brake system that operates using hydraulic pressure adjusted by an actuator. The brake systems 511, 512 may be configured to have the same function. Alternatively, one of the brake systems 511, 512 may be configured to independently control the braking force of each wheel during vehicle traveling, and the other may be configured to control the same braking force in each wheel during vehicle traveling.

Each of the brake systems 511, 512 generates a braking command to the braking device in accordance with a predetermined control command transmitted from the ADK 3 through the vehicle control interface 4. The brake systems 511, 512 control the braking devices using, for example, the braking command generated by any one of the brake systems. Further, the brake systems 511, 512 control the braking devices by using the braking command generated by the other brake system in a case where the abnormality occurs in any one of the brake systems.

The wheel speed sensor 52 is connected to the brake system 512 in this example. The wheel speed sensor 52 is provided in each of the wheels of the vehicle 1, for example. The wheel speed sensor 52 detects the rotation speed of each wheel and outputs the detected rotation speed to the brake system 512. The brake system 512 outputs the rotation speed of each wheel to the VCIB 41 as one of the pieces of information included in the vehicle information.

The steering systems 531, 532 are configured to control a steering angle of a steering wheel of the vehicle 1 using a steering device. The steering device includes, for example, a rack and pinion type electric power steering (EPS) in which a steering angle can be adjusted by an actuator.

The steering systems 531, 532 have the same function. Each of the steering systems 531, 532 generates a steering command to the steering device in accordance with a predetermined control command output from the ADK 3 through the vehicle control interface 4. The steering systems 531, 532 control the steering device using, for example, the steering command generated by any one of the steering systems. In a case where the abnormality occurs in any one of the steering systems 531, 532, the steering device is controlled by using the braking command generated by the other steering system.

The pinion angle sensor 541 is connected to the steering system 531. The pinion angle sensor 542 is connected to the steering system 532. Each of the pinion angle sensors 541, 542 detects a rotation angle (pinion angle) of a pinion gear connected to a rotation shaft of the actuator, and outputs the detected pinion angle to the steering systems 531, 532, respectively.

The EPB system 551 is configured to control the EPB provided in the wheels of the vehicle 1. The EPB is provided separately from the braking devices of the brake systems 511, 512, and fixes the wheels by the operation of the actuator. The actuator may be an actuator that can adjust the oil pressure supplied to the braking device separately from the brake systems 511, 512. The EPB, for example, operates a drum brake for a parking brake using an actuator to fix wheels.

The P-lock system 552 is configured to control a P lock device provided in the transmission of the vehicle 1. More specifically, a gear (lock gear) is provided to be connected to a rotating element in the transmission. Further, a parking lock pole whose position can be adjusted by an actuator is provided for the teeth of the lock gear. The P lock device fixes the rotation of the output shaft of the transmission by fitting a protrusion portion positioned at the tip end of the parking lock pole.

The propulsion system 56 is configured to switch the shift range using the shift device and to control the driving force of the vehicle 1 in the traveling direction using the drive source. The shift device is configured to select any one of a plurality of shift ranges. The drive source may include a motor generator, an engine, and the like.

The PCS 57 executes control for avoiding the collision of the vehicle 1 or reducing the damage by using the camera/radar 58. More specifically, the PCS 57 is connected to the brake system 512. The PCS 57 detects the object in front by using the camera/radar 58 and determines whether there is a possibility of collision with the vehicle 1 based on a distance to the object. When the PCS 57 determines that there is a possibility of a collision, the PCS 57 outputs a braking command to the brake system 512 such that the braking force is increased.

The body system 59 is configured to control various components (a direction indicator, a horn, a wiper, or the like) according to, for example, a traveling state or a traveling environment of the vehicle 1.

Systems other than the brake systems 511, 512 and the steering systems 531, 532 are also configured to control the corresponding devices in accordance with predetermined control commands transmitted from the ADK 3 to the vehicle control interface 4. Specifically, the EPB system 551 receives the control command from the ADK 3 via the vehicle control interface 4, and controls the EPB in accordance with the control command. The P-lock system 552 receives the control command from the ADK 3 via the vehicle control interface 4, and controls the P lock device in accordance with the control command. The propulsion system 56 receives the control command from the ADK 3 via the vehicle control interface 4, and controls the shift device and the drive source in accordance with the control command. The body system 59 receives the control command from the ADK 3 via the vehicle control interface 4, and controls the component parts in response to the control command.

An operation device that can be manually operated by the user may be separately provided for the above-described braking device, the steering device, the EPB, the P lock, the shift device, the drive source, and the like.

### Brake Pedal Control

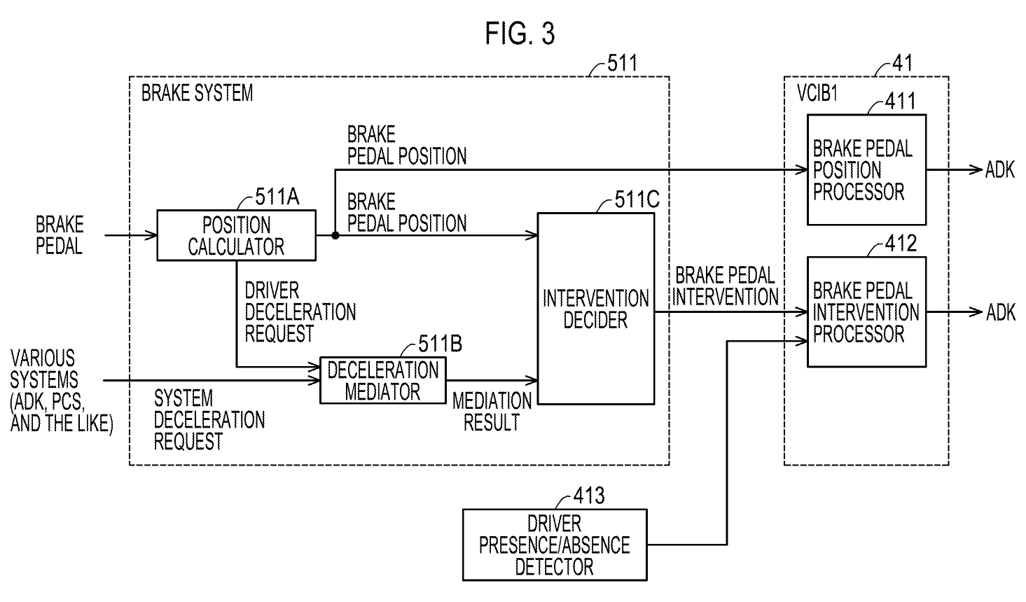

FIG. 3 is a functional block diagram of brake pedal control in the vehicle 1. With reference to FIGS. 2 and 3, the brake system 511 includes a position calculator 511A, a deceleration mediator 511B, and an intervention decider 511C. Note that, for convenience of description, the brake system 511 is described as an example here, but the brake system 512 may also have the same function as the brake system 511.

The position calculator 511A receives a signal indicating the depression amount of the brake pedal 50 by the driver from the brake position sensor. The position calculator 511A further outputs a brake pedal position signal indicating a brake pedal depression amount to the VCIB 41 and the intervention decider 511C. The position calculator 511A outputs a deceleration request according to the depression amount of the brake pedal 50 by the driver to the deceleration mediator 511B.

The deceleration mediator 511B receives the deceleration request from the position calculator 511A, receives the deceleration request from various systems, and mediates the two deceleration requests. More specifically, the deceleration mediator 511B adds the two decelerations. The deceleration mediator 511B outputs the mediation result of the two speed reduction requests (in this example, the sum of the two speed reductions) to the intervention decider 511C.

Hereinafter, the deceleration request from the position calculator 511A is referred to as a “driver deceleration request”, and the deceleration request from the various systems is referred to as a “system deceleration request”, so that both are distinguished.

The source of the system deceleration request is, for example, the ADK 3, but is not limited thereto, and may be, for example, the PCS 57. When the source of the system deceleration request is the ADK 3, the deceleration mediator 511B receives the system deceleration request via the vehicle control interface 4.

The intervention decider 511C receives the brake pedal position signal from the position calculator 511A and receives the mediation result from the deceleration mediator 511B. The intervention decider 511C generates a brake pedal intervention signal based on the brake pedal position signal and the mediation result, and outputs the generated brake pedal intervention signal to the VCIB 41.

The VCIB 41 includes a brake pedal position processor 411 and a brake pedal intervention processor 412. Although solely the VCIB 41 is illustrated in FIG. 3, the other VCIB 42 that is redundant also has the same function.

The brake pedal position processor 411 receives a brake pedal position signal from the brake system 511 (position calculator 511A) and executes a predetermined process on the brake pedal position signal. The brake pedal position processor 411 outputs the brake pedal position signal after the process to the ADK 3.

The brake pedal position signal output to the ADK 3 gives a brake pedal depression amount according to a detection value of a brake position sensor when the vehicle 1 is normal. The brake pedal depression amount is represented by a value within a range of 0% to 100%. Note that, due to an assembly error of the brake pedal and/or the brake position sensor, the brake pedal depression amount may exceed 100%.

On the other hand, the brake pedal position signal output to the ADK 3 gives a fail-safe value when an abnormality occurs in the vehicle 1, specifically, when the brake position sensor fails. The fail-safe value is a value corresponding to the brake pedal depression amount = 100%, and is, for example, 0xFF.

The brake pedal intervention processor 412 receives the brake pedal intervention signal from the intervention decider 511C and executes a predetermined process on the brake pedal intervention signal. The brake pedal intervention processor 412 outputs the brake pedal intervention signal after the processing to the ADK 3. Note that the intervention decider 511C may execute the process, and the brake pedal intervention processor 412 may relay the brake pedal intervention signal from the intervention decider 511C to the ADK 3.

### Brake Pedal Intervention

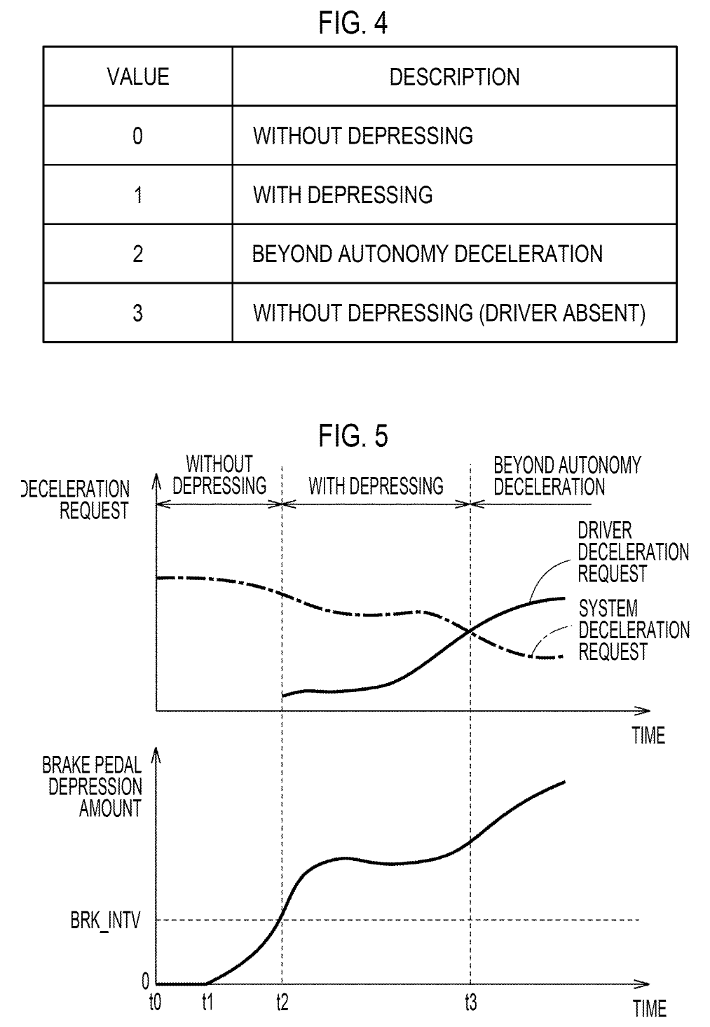

Hereinafter, the content represented by the brake pedal intervention signal will be described. FIG. 4 is a diagram for describing a brake pedal intervention signal. With reference to FIG. 4, the brake pedal intervention signal takes any one of the values of 0, 1, and 2.

When the value of the brake pedal intervention signal is 0, the brake pedal intervention signal indicates that the brake pedal 50 is not depressed. When the value of the brake pedal intervention signal is 1, the brake pedal intervention signal indicates that the brake pedal 50 is being depressed. When the value of the brake pedal intervention signal is 2, the brake pedal intervention signal indicates that a deceleration request (driver deceleration request) due to the depression of the brake pedal 50 exceeds a deceleration request (system deceleration request) from the ADK 3 or the like. This state is referred to as “beyond autonomy deceleration”.

FIG. 5 is a time chart showing an example of the transition of the brake pedal intervention signal in the vehicle 1. In FIG. 5, a horizontal axis represents an elapsed time. The vertical axis represents the deceleration request and the brake depression amount from the top.

With reference to FIG. 5, at an initial time t0, the brake depression amount is 0%. In this case, the value of the brake pedal intervention signal is 0, and the brake pedal intervention signal indicates that the brake pedal 50 is not depressed.

At time t1, the driver starts to depress the brake pedal 50. At a subsequent time t2, the brake depression amount is higher than a predetermined threshold value (BRK_INTV). The threshold value is a value for providing a so-called play to the brake pedal 50, and is set to, for example, several %. When the brake depression amount exceeds the threshold value BRK_INTV, the value of the brake pedal intervention signal changes from 0 to 1. The brake pedal intervention signal at this time indicates that the brake pedal 50 is depressed.

At time t3, the brake depression amount (driver deceleration request) corresponding to the depression amount of the brake pedal 50 is higher than the system deceleration request. Then, the value of the brake pedal intervention signal changes from 1 to 2. The brake pedal intervention signal at this time represents the beyond autonomy deceleration.

### Problem and Solution

In the MaaS vehicle, since both scenes in which the driver is present and in which the driver is not present are assumed, the determination is made whether the brake pedal 50 is operated regardless of the presence or absence of the driver. However, in the first place, in a scene where the driver is absent, the information as to whether the brake pedal 50 is operated is not needed. In the above-described configuration, the presence or absence of the depression of the brake pedal 50 is determined from the brake depression amount. However, the brake pedal 50 may move due to a factor other than the operation of the driver. For example, when the deceleration request from the ADK 3 is large, the brake pedal 50 may be slightly moved due to the influence of the inertia applied to the brake pedal 50. In addition, regarding the brake pedal 50, in addition to the inertia, a case occurs in which a change in brake pressure is instantaneously generated due to a problem of the responsiveness of the brake valve, and thus a misjudgment is made that the brake is depressed. As described above, in a scene where the determination of the operation of the brake pedal 50 is not originally needed, there is a possibility that the depression of the brake pedal 50 is erroneously determined.

Therefore, the vehicle 1 is configured to attach and detach the ADK 3 that issues an instruction for autonomous driving and to autonomously drive. The vehicle 1 includes the VP 5, a brake pedal 50 that receives a braking operation of the driver of the VP 5, brake systems 511, 512, a driver presence/absence detector 413 that detects whether the driver is on board, and VCIBs 41, 42 that relay control communication between the ADK 3 and the brake systems 511, 512. The brake systems 511, 512 brake the VP 5 according to the braking operation received by the brake pedal 50 or the braking instruction from the ADK 3. The VCIB 41, 42 determines whether the driver gets on the vehicle by using the detection result of the driver presence/absence detector 413. When the determination is made that the driver gets on the vehicle, the brake pedal intervention signal of the value according to the braking operation received by the brake pedal 50 is output to the ADK 3. When the determination is made that the driver does not get on the vehicle, the brake pedal intervention signal of the first value indicating that the braking operation is not performed is output to the ADK 3.

As a result, when the driver is not in the vehicle, the brake pedal intervention signal indicating that the braking operation is not performed is output to the ADK 3 regardless of whether the braking operation is received by the brake pedal 50. As a result, it is possible to prevent the erroneous determination of the depression of the brake pedal 50.

Returning to FIG. 3, the VP 5 further includes a driver presence/absence detector 413. The driver presence/absence detector 413 detects whether the driver is seated in the driver’s seat. The driver presence/absence detector 413 is constituted of a seat sensor that detects whether the driver is seated in the driver’s seat in the present embodiment. The driver presence/absence detector 413 outputs information indicating whether the driver is seated in the driver’s seat to the brake pedal intervention processor 412.

Returning to FIG. 4, the brake pedal intervention signal takes any one value of 0, 1, 2, and 3. When the value of the brake pedal intervention signal is 3, the brake pedal intervention signal indicates that the driver is not present in the driver’s seat (absence) and the brake pedal 50 is not depressed. When the value of the brake pedal intervention signal is 0, 1, or 2 as described above, the driver is seated in the driver’s seat.

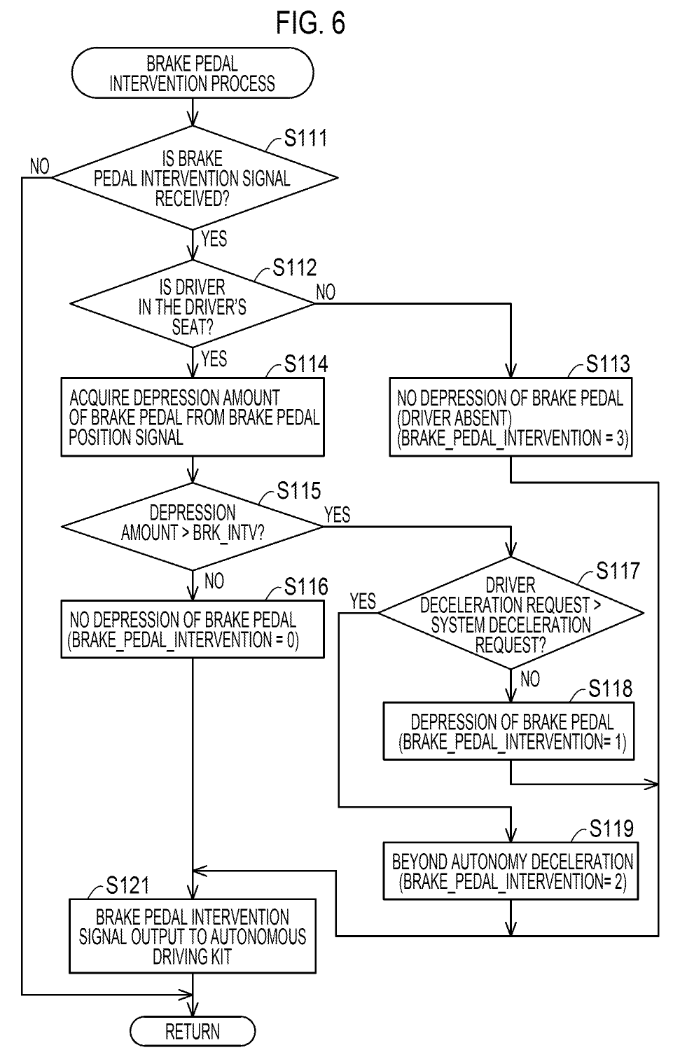

FIG. 6 is a flowchart showing a flow of a brake pedal intervention process executed by the VCIBs 41, 42 in the present embodiment. With reference to FIG. 6, the brake pedal intervention process is called and executed from the higher-level process by the processors of the VCIBs 41, 42 at a predetermined cycle. Each step included in the flowchart is basically realized by software processing by the vehicle 1 (VP 5 or vehicle control interface 4). However, the function may be realized by dedicated hardware (electric circuit) prepared in the VP 5 or the vehicle control interface 4.

The processors of the VCIB 41, 42 determine whether the brake pedal intervention signal is received from the brake system 511 (S111). When determination is made that the brake pedal intervention signal is not received (NO in S111), the processor of the VCIB 41, 42 returns the processing to the upper processing of the processing.

On the other hand, when determination is made that the brake pedal intervention signal is received (YES in S111), the processors of the VCIBs 41, 42 determine whether the driver is in the driver’s seat by using the information from the driver presence/absence detector 413 (S112). In a case where the determination is made that the driver is not in the driver’s seat (NO in S112). In this case, the processors of the VCIBs 41, 42 set the value of the brake pedal intervention signal to 3 to indicate that the driver is not present in the driver’s seat (absent) and the brake pedal 50 is not depressed (S113).

When determination is made that the driver is in the driver’s seat (YES in S112), the processors of the VCIBs 41, 42 acquire the brake application amount indicated by the brake pedal position signal (S114).

The processors of the VCIB 41, 42 determine whether the brake depression amount exceeds the threshold value BRK_INTV (S115). In a case where a determination is made that the brake depression amount is equal to or less than a threshold value BRK_INTV (NO in S115). In this case, the processors of the VCIBs 41, 42 set the value of the brake pedal intervention signal to zero to indicate that the driver is in the driver’s seat but the brake pedal 50 is not depressed (S116).

On the other hand, in a case where a determination is made that the brake depression amount exceeds the threshold value BRK_INTV (YES in S115). In that case, the processors of the VCIBs 41, 42 determine whether the driver deceleration request based on the brake application amount exceeds the system deceleration request (S117). In a case where a determination is made that the driver deceleration request does not exceed the system deceleration request (NO in S117). In this case, the processors of the VCIBs 41, 42 set the value of the brake pedal intervention signal to 1, indicating that the driver is in the driver’s seat and the brake pedal 50 is depressed (S118).

On the other hand, in a case where a determination is made that the driver deceleration request exceeds the system deceleration request (YES in S117). In this case, the processors of the VCIBs 41, 42 set the value of the brake pedal intervention signal to 2 to indicate that the driver is in the driver’s seat and the beyond autonomy deceleration has occurred (S119).

After S113, S116, S118, or S119, the processor of each of the VCIBs 41, 42 outputs the brake pedal intervention signal set to any of 0, 1, 2, and 3 to the ADK 3 (S121). Thereafter, the processor of the VCIB 41, 42 returns the processing to be executed to the upper processing of the processing.

### Modification

(1) In the embodiment described above, as shown in FIG. 3, the driver presence/absence detector 413 is configured by the seat occupancy sensor. However, the present disclosure is not limited thereto, and the driver presence/absence detector 413 may have another configuration as long as the driver presence or absence can be detected. For example, a driver monitoring camera that captures a driver sitting in a driver’s seat may be used. Alternatively, the gripping sensor that detects whether the driver grips the steering wheel may be used.

(2) The above-described embodiment can be regarded as a disclosure of the vehicle 1, the VP 5, or the VCIB 41, 42, or can be regarded as a disclosure of a control method or a control program executed by the vehicle 1, the VP 5, or the VCIB 41, 42.

### SUMMARY

(1) As shown in FIGS. 1 and 2, the vehicle 1 is configured to be detachable with the ADK 3 that issues an instruction for autonomous driving and to be capable of autonomous driving. As shown in FIG. 1 to FIG. 3, the vehicle 1 includes a VP 5, a brake pedal 50 that receives a braking operation of the driver of the VP 5, brake systems 511, 512, the driver presence/absence detector 413, and VCIBs 41, 42 that relay control communication between the ADK 3 and the brake systems 511, 512. The brake systems 511, 512 brake the VP 5 according to the braking operation received by the brake pedal 50 or the braking instruction from the ADK 3. The driver presence/absence detector 413 detects whether the driver is present in the vehicle. As shown in FIGS. 3 to 6, the VCIBs 41, 42 determine whether the driver gets on the vehicle by using the detection result of the driver presence/absence detector 413 (for example, S112). When the determination is made that the driver gets on the vehicle, the brake pedal intervention signal of the value (for example, 0, 1, 2) according to the braking operation received by the brake pedal 50 is output to the ADK 3 (for example, from S114 to S119, S121). When the determination is made that the driver does not get on the vehicle, the brake pedal intervention signal of the first value (for example, 3) indicating that the braking operation is not performed is output to the ADK 3 (for example, S113, S121).

As a result, when the driver is not in the vehicle, the brake pedal intervention signal indicating that the braking operation is not performed is output to the ADK 3 regardless of whether the braking operation is received by the brake pedal 50. As a result, it is possible to prevent the erroneous determination of the depression of the brake pedal 50.

(2) As shown in FIGS. 3 to 6, the VCIBs 41, 42 may be determined that the driver gets on the vehicle and there is no braking operation. In this case, the brake pedal intervention signal of the second value (for example, 0) that is different from the first value and indicating that the braking operation is not performed, may be output to the ADK 3 (for example, S116, S121).

As a result, it is possible to distinguish between a case where the driver is on board and a case where the driver is not on board and to transmit the information to the ADK 3.

(3) As shown in FIGS. 3 to 6, the VCIBs 41, 42 may be determined that the driver gets on the vehicle and the operation amount of the brake pedal 50 is smaller than a threshold value. In this case, the brake pedal intervention signal of the second value may be output to the autonomous driving kit (for example, from S114 to S116 and S121).

As a result, it is possible to appropriately inform the ADK 3 that the brake pedal 50 is not operated when the driver is in the vehicle.

(4) As shown in FIGS. 3 to 6, the VCIBs 41, 42 may be a system deceleration request including a braking instruction when the driver is determined to be on the vehicle, when the operation amount of the brake pedal 50 is larger than a threshold value, and when the deceleration request according to the operation amount of the brake pedal 50 is lower than the system deceleration request including the braking instruction. In this case, the brake pedal intervention signal of the third value (for example, 1) indicating that the braking operation is performed may be output to the ADK 3 (for example, S114, S115, S117, S118). When the determination is made that the driver gets on the vehicle, when the operation amount of the brake pedal 50 is larger than a threshold value, and when the deceleration request according to the operation amount of the brake pedal 50 is higher than the system deceleration request including the braking instruction. In this case, the brake pedal intervention signal of the fourth value (for example, 2) indicating that the deceleration request by the braking operation exceeds the system deceleration request may be output to the ADK 3 (for example, S114, S115, S117, S119).

As a result, it is possible to distinguish between the deceleration request due to the braking operation of the driver and the system deceleration request when the driver is on board and to transmit the deceleration request to the ADK 3.

(5) As shown in FIG. 3, the VCIBs 41, 42 may further output a brake pedal position signal according to the operation amount of the brake pedal 50 by the driver to the ADK 3.

As a result, the operation amount of the brake pedal 50 by the driver can be appropriately transmitted to the ADK 3.

The embodiment disclosed is to be considered merely illustrative and not restrictive in all respects. The scope of the present disclosure is indicated by the scope of claims rather than by the description of the above-described embodiment, and is intended to include all modifications within the scope and meaning equivalent to the scope of the claims.

What is claimed is:

1. A vehicle configured to enable autonomous driving through an autonomous driving kit that is attachable and detachable and that issues an instruction for autonomous driving, the vehicle comprising:
a vehicle platform;
a brake pedal configured to receive a braking operation of a driver of the vehicle platform;
a braking function unit configured to brake the vehicle platform corresponding to the braking operation received by the brake pedal or a braking instruction from the autonomous driving kit;
a driver detector configured to detect whether the driver is on board the vehicle; and
a vehicle control interface box configured to relay control communication between the autonomous driving kit and the braking function unit, wherein:
the vehicle control interface box is configured to:
determine whether the driver is on board the vehicle by using a detection result of the driver detector;
output, to the autonomous driving kit, a brake pedal intervention signal of a value corresponding to the braking operation received by the brake pedal, in a case where a determination is made that the driver is on board the vehicle; and
output, to the autonomous driving kit, a brake pedal intervention signal of a first value indicating that the braking operation is not performed, in a case where a determination is made that the driver is not on board the vehicle.

2. The vehicle according to claim 1, wherein the vehicle control interface box is configured to output, to the autonomous driving kit, a brake pedal intervention signal of a second value that is different from the first value and indicating that the braking operation is not performed, in a case where a determination is made that the driver is on board the vehicle and the braking operation is not performed.

3. The vehicle according to claim 2, wherein the vehicle control interface box is configured to output, to the autonomous driving kit, the brake pedal intervention signal of the second value, in a case where a determination is made that the driver is on board the vehicle and an operation amount of the brake pedal is smaller than a threshold value.

4. The vehicle according to claim 3, wherein the vehicle control interface box is configured to:
output, to the autonomous driving kit, a brake pedal intervention signal of a third value indicating that the braking operation is performed, in a case where a determination is made that the driver is on board the vehicle, the operation amount of the brake pedal is larger than the threshold value, and a deceleration request corresponding to the operation amount of the brake pedal is lower than a system deceleration request including the braking instruction; and
output, to the autonomous driving kit, a brake pedal intervention signal of a fourth value indicating that the deceleration request due to the braking operation exceeds the system deceleration request, in a case where a determination is made that the driver is on board the vehicle, the operation amount of the brake pedal is larger than the threshold value, and the deceleration request corresponding to the operation amount of the brake pedal is higher than the system deceleration request including the braking instruction.

5. The vehicle according to claim 1, wherein the vehicle control interface box is configured to further output a brake pedal position signal corresponding to an operation amount of the brake pedal by the driver to the autonomous driving kit.
